(19) United States
(12) Patent Application Publication
(10) Pub. No.: US 2017/0076368 A1
(43) Pub. Date: Mar. 16, 2017

(54) Method and Device for Processing Card Application Data

(71) Applicant: Xiaomi Inc., Beijing (CN)

(72) Inventors: Pengfei CHEN, Beijing (CN); Zhining WU, Beijing (CN); Min SHANG, Beijing (CN)

(73) Assignee: Xiaomi Inc.

(21) Appl. No.: 15/071,613

(22) Filed: Mar. 16, 2016

(30) Foreign Application Priority Data
Sep. 15, 2015 (CN) 201510587718.X

(51) Int. Cl. G06Q 40/02; G06Q 20/34

(52) U.S. Cl. CPC G06Q 40/025; G06Q 20/34

(57) ABSTRACT

Embodiments herein relate to a method and device for processing card application data. The method includes receiving a card application request from a user, acquiring historical communication data related to the user in response to the request, extracting user information from the historical communication data, displaying an online card application form on a display, and entering the user information into the online card application form.

### CROSS-REFERENCE TO RELATED APPLICATIONS

This application claims priority to Chinese Patent Application 201510587718.X filed on Sep. 15, 2015, the entire content of which is incorporated herein by reference.

### TECHNICAL FIELD

The present disclosure generally relates to the field of data processing, and in particular to a method and device for processing card application data.

### BACKGROUND

With continuous development of mobile Internet technologies, an increasing number of services become available on equipment such as a computer, a mobile phone, and a tablet computer. For example, many banks introduce a service of online credit card application. Such online applications are well received by users. As the number of cards issued by banks increases each year, online card applications increases, too.

The new form of online card application has its shortcomings With existing online card application, a user is required to manually fill in, through a browser, identity information, income information, a mailing address, and other user qualification distinguishing information such as educational background, work experience, etc. A user has to take time and trouble to fill in much information manually, which is error-prone.

### SUMMARY

According to a first aspect herein, a method for processing an online application form includes receiving an online application request associated with a user, acquiring historical communication data related to the user in response to the online application request, extracting user information from the historical communication data, displaying the online application form on a screen of the smart device, and entering the user information into the online application form.

According to a second aspect herein, a device for processing card application data includes a processor, and a memory configured for storing an instruction executable by the processor. The processor is configured to perform receiving an online card application request from a user, acquiring historical communication data related to the user in response to the online card application request, extracting user information from the historical communication data, displaying an online card application form on a screen of the smart device, and entering the user information into the online card application form.

According to a third aspect herein, a non-transitory computer-readable storage medium has stored therein instructions that, when executed by a processor, cause the processor to perform a method for processing card application data.

Note that the general description above and detailed description below are exemplary and explanatory only, and are not intended for limiting the present disclosure.

### BRIEF DESCRIPTION OF THE DRAWINGS

Accompanying drawings herein are incorporated in and constitute a part of this specification, illustrate embodiments consistent with the present disclosure and, together with the description, serve to explain the principles of the present disclosure.

FIG. 1 is a flowchart of a method for processing card application data according to an exemplary embodiment.

FIG. 2 is a flowchart of extracting user information according to an exemplary embodiment.

FIG. 3 is a schematic diagram of acquiring user information according to an exemplary embodiment.

FIG. 4 is a diagram of a scene of a method for processing card application data according to an exemplary embodiment.

FIG. 5 is a flowchart of another method for processing card application data according to an exemplary embodiment.

FIG. 6 is a block diagram of a device for processing card application data according to an exemplary embodiment.

FIG. 7A is a block diagram of another device for processing card application data according to an exemplary embodiment.

FIG. 7B is a block diagram of another device for processing card application data according to an exemplary embodiment.

FIG. 7C is a block diagram of another device for processing card application data according to an exemplary embodiment.

FIG. 7D is a block diagram of another device for processing card application data according to an exemplary embodiment.

FIG. 8A is a block diagram of another device for processing card application data according to an exemplary embodiment.

FIG. 8B is a block diagram of another device for processing card application data according to an exemplary embodiment.

FIG. 9 is a block diagram of a device for processing card application data, according to an exemplary embodiment.

### DETAILED DESCRIPTION

Reference will now be made in detail to exemplary embodiments, examples of which are illustrated in the accompanying drawings. In drawing-related description below, unless indicated otherwise, identical references in different drawings represent identical or like elements. Implementations in the following exemplary embodiments do not represent all implementations according to the present disclosure. On the contrary, they are merely examples of devices and methods according to some aspects of the present disclosure as recited in the appended claims.

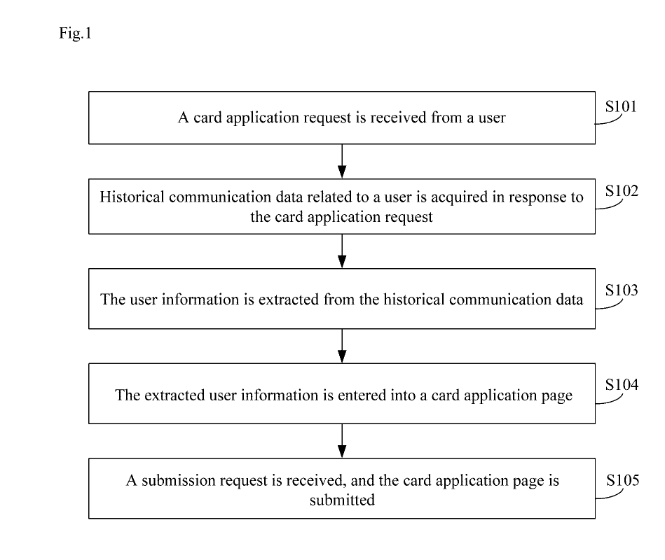

FIG. 1 is a flowchart of a method for processing card application data according to an exemplary embodiment. As shown in FIG. 1, the method for processing card application data may apply to terminal equipment such as a mobile phone, a tablet computer, a Personal Digital Assistant (PDA), etc. A preset operating system or a preset Application (APP) may be installed in the terminal equipment. The method includes steps 101-105 as follows.

In step 101, a card application request is received from a user.

In the embodiment, when a user expects to apply a card on line using terminal equipment such as a mobile phone, the user may visit an online card application page. When the user clicks on an entry “online card application”, the terminal equipment such as a mobile phone may receive the card application request.

In step 102, historical communication data related to a user is acquired in response to the card application request. The historical communication data may include user information that would be required for the card application.

After the card application request is received, the historical communication data including the user information required for card application may be acquired in response to the card application request. For example, a short message including financial information may be acquired in response to the card application request. Payment account registration information may also be acquired in response to the card application request. A historical payment record may also be acquired in response to the card application request. Email client data may further be acquired in response to the card application request.

In step 103, the user information is extracted from the historical communication data.

The user information may include, but is not limited to, one or more of: income information, identity information, a mailing address, email information, information on a bank card of the user, and the like.

When the acquired historical communication data includes a short message, the short message may be analyzed, and the income information of the user may be extracted according to a result of the analysis.

When the acquired historical communication data includes payment account registration information, the identity information of the user may be extracted from the payment account registration information.

When the acquired historical communication data includes historical payment record, the mailing address of the user may be extracted from the historical payment record.

When the acquired historical communication data includes email client data, the email information of the user may be extracted from the email client data.

In step 104, the extracted user information is correspondingly entered into a card application page.

In the embodiment, after the user information is extracted according to the card application request, the extracted user information may be correspondingly entered into the card application page, which may be done in many modes, two of which are listed below.

In Mode 1, the user information may be matched to an entry to be filled in on the card application page; the user information may be entered into an entry to be filled in corresponding to the user information according to a matching result.

For example, the card application page may include a number of entries to be filled in, such as an entry for the income of the user, an entry for a mailing address of the user, etc. After the user information is extracted, by character matching, the extracted income information of the user may be written into the entry for the income, and the mailing address of the user may be written into the entry for the mailing address.

In such a mode, the extracted information may be automatically written into the card application page. With such a simple information writing process, a page turning operation due to a small screen of a mobile terminal such as a mobile phone may be avoided.

In Mode 2, a trigger instruction for triggering an entry to be filled in on the card application page may be received. User information corresponding to the triggered entry to be filled in may be displayed according to the trigger instruction. A writing instruction for writing the displayed user information may be received. The displayed user information may be written into the triggered entry to be filled in according to the writing instruction.

For example, when the user clicks on an entry to be filled in on the card application page, automatically extracted user information corresponding to the entry may pop up. For example, when identity information of the user is clicked on, the extracted ID card number of the user may pop up. When the user clicks to select an entry for the ID card number, the writing instruction is received, and then user information corresponding to the selected entry, namely, the ID card number, may be written into the selected entry to be filled in.

In addition, note that the user information may be extracted from the historical communication data before or after receiving the trigger instruction. For example, after the trigger instruction is received, user information may be extracted from the historical communication data, and then extracted user information corresponding to the trigger instruction may pop up.

In such a mode, extracted information may be written into the card application page based on an operation of the user, such that a workload for manually inputting information by the user may be effectively reduced.

In step 105, a submission request is received, and the card application page is submitted according to the submission request.

In the embodiment, after the extracted user information is correspondingly written into the card application page, when the user clicks on a “submit” key, the terminal equipment such as the mobile phone may receive the submission request and submit, according to the submission request, the card application page to a card application agency. After receiving the card application page, the card application agency may audit the information in the page and issue a card after the information passes the audit.

With the method for processing card application data according to an aforementioned embodiment, historical communication data including user information of a user required for card application may be acquired according to a received card application request, the user information may be extracted from the historical communication data, the extracted user information may be correspondingly written into a card application page, such that the user is not required to manually fill in the user information, saving time and trouble, reducing a probability of error, facilitating online card application by the user. Although the disclosure describes processing an online card application, any online application form, for example, a cable subscription form, a mobile subscription form, or a mortgage application form may be automatically filled in according to the disclosure.

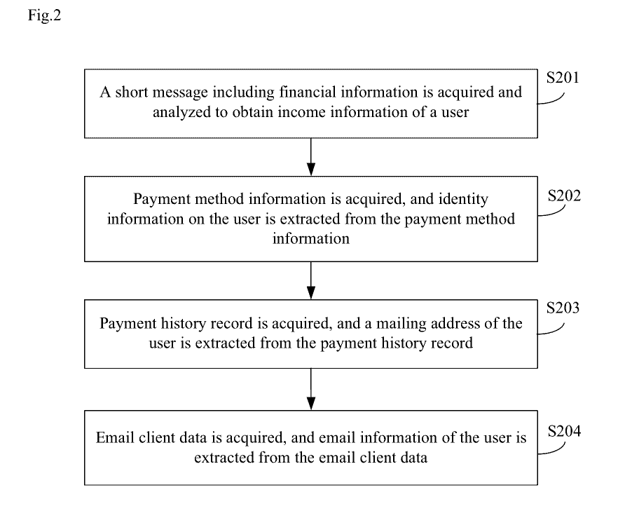

FIG. 2 is a flowchart of extracting user information according to an exemplary embodiment. As shown in FIG. 2, the method may include steps as follows.

In step 201, a short message including financial information is acquired and analyzed to obtain income information of a user. The short message may be sent by the user, or the short message may be addressed to the user. In the embodiment, a terminal device such as a mobile phone may acquire a short message including financial information such as a direct deposit notice for the user from a message database in the mobile phone or from a server that the mobile phone communicates with. Then, the terminal device analyzes the short message and extract the income information of the user from the short message. The income information of the user for a credit card application may require information on annual income of the user or on monthly income of the user.

When information on annual income is required, short messages regarding income such as direct deposits from a certain entity over the period of 12 months may be analyzed to obtain information on the annual income of the user. When information on monthly income is required, short messages regarding income such as direct deposits from a certain entity over 12 months may be analyzed and averaged to obtain information on the monthly income of the user.

In step 202, payment method information is acquired, and identity information on the user is extracted from the payment method information.

In registering a payment method, the user may fill in her identity information such as a name, a date of birth, a ID card number, for example a driver's license number, or a state ID number. Then, the terminal device such as a mobile phone may extract the identity information on the user from the payment method information on the user.

In addition, in registering a payment method, the user may also fill in information on a credit or debit card. The information on a credit or debit card of the user may be stored in the terminal device.

In step 203, a payment history record is acquired, and a mailing address of the user is extracted from the payment history record.

In the embodiment, the terminal device may acquire a payment history record for water, electricity, gas and the like from a payment platform, and analyze the payment history record for water, electricity, gas and the like to acquire the mailing address of the user.

In step 204, email client data is acquired, and email information of the user is extracted from the email client data.

In the embodiment, the terminal device may acquire the email client data from its memory or from a server it communicates with and extract an email account of the user from the email client data. In addition, other information such as educational background and work experience of the user may further be acquired from the email account.

Note that in the embodiment, the income information, the identity information, the mailing address and the email information of the user are acquired through steps 201-204. In a practical application, only part of the user information may be acquired through any one, two or three steps of steps 201-204. In addition, there is no strict sequence for executing steps 201-204. For example, Step 202 may be executed before or after Step 201.

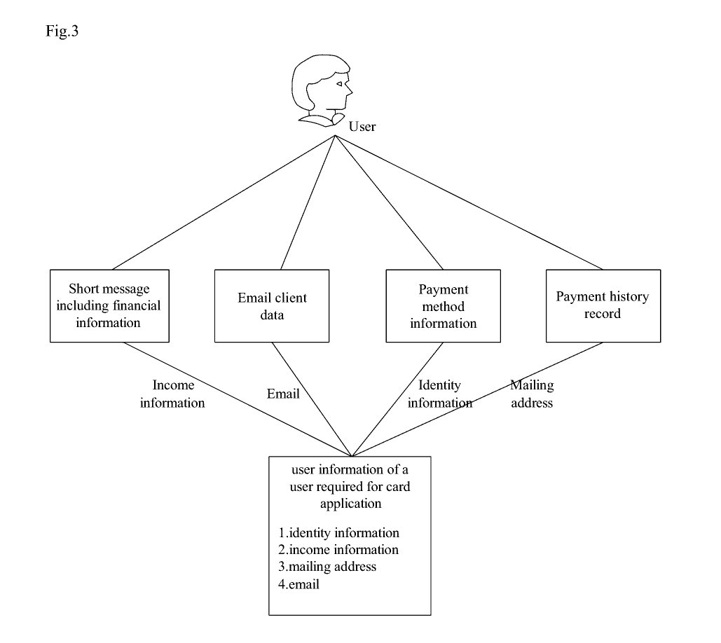

In addition, FIG. 3 clearly shows a process of acquiring the user information by different means according to the embodiment shown in FIG. 2. It may be seen in FIG. 3 that steps 201-204 are parallel to each other.

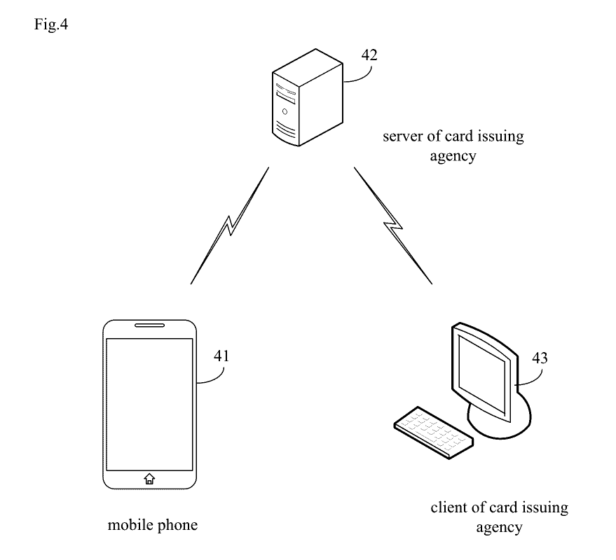

An embodiment herein may be described exemplarily below with reference to FIG. 4. As shown in FIG. 4, when a user applies a credit card online using a mobile phone 41, an operating system of the mobile phone 41 or an APP installed on the mobile phone 41 may acquire and analyze a direct deposit message for the user to acquire income information of the user. In addition, the mobile phone 41 may interact with a payment system to acquire payment method information and acquire identity information of the user according to the payment method information. The mobile phone 41 may also acquire utility bill data for the user such as a gas payment history using an APP such as a utility payment APP installed in the mobile phone 41, and acquire a mailing address of the user according to the gas payment history. After the acquired information is written into a card application page, the mobile phone 41 may receive a triggering operation of the user over a “submit” key, and submit the card application page according to the triggering operation. For example, the mobile phone 41 may submit the card application page to a server 42 of a card application agency. A client 43 of the card application agency may then acquire the card application page from the server 42, and a staff of the card application agency may audit information in the card application page, issue a credit card after the information passes the audit, and mail the credit card to the mailing address provided on the card application page. Note that the mobile phone 41 may also be replaced by other terminal equipment such as a tablet computer installed with a preset operating system or a required APP, that is, the tablet computer may extract the user information, write the extracted user information into the card application page, submit the card application page, etc.

In the embodiment, various kinds of acquired historical communication data are checked to be objective, authentic and unlikely to be faked, and thus the user information extracted from the historical communication data are objective and accurate, increasing data authenticity, reducing a deviation due to manually filling in information by the user, reducing a risk of the card issuing agency. Meanwhile, information may be extracted flexibly in multiple modes that are easy to implement.

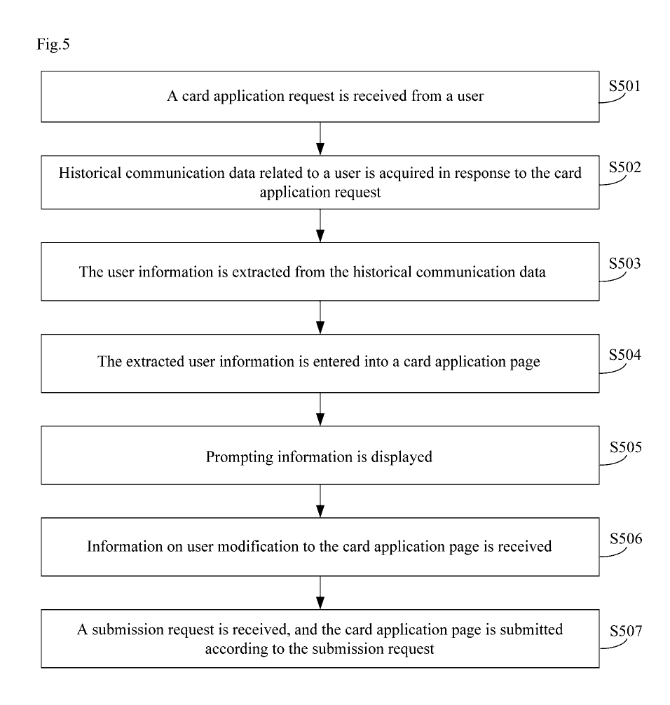

FIG. 5 is a flowchart of a method for processing card application data according to an exemplary embodiment. As shown in FIG. 5, the method may include steps as follows. Steps 501-504 are the same as steps 101-104, and will not be repeated here.

In step 505, prompting information is displayed. The prompting information may be configured for prompting the user to check the user information. In the embodiment, as the extracted information may be wrong, after the extracted user information is correspondingly written into the card application page, the prompting information may be displayed. For example, prompting information “Please check user information filled in” may be displayed.

In step 506, information on user modification to the card application page is received. In the embodiment, the user may check the user information according to the prompting information, and when a piece of information, such as some information in the mailing address, is found to be wrong, the user may make modification manually to correct the information.

After the user has manually corrected the information, the terminal equipment such as the mobile phone may receive information on the user modification.

In addition, when all information filled in on the card application page is correct, the user is not required to modify the user information written in the card application page, and may directly submit the card application page.

In step 507, a submission request is received, and the card application page is submitted according to the submission request. Step 507 may be implemented same as Step 105, which will not be repeated here.

In the embodiment, by displaying prompting information, the user may be prompted to check the information, facilitating increasing accuracy of the user information. The information on user modification to the card application page may be received, improving accuracy of the user information.

Corresponding to a method for processing card application data according to an aforementioned embodiment, an embodiment herein further provides a device for processing card application data.

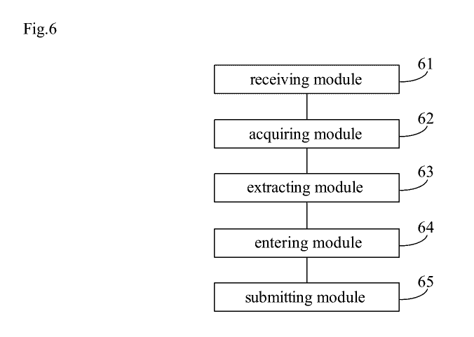

FIG. 6 is a block diagram of a device for processing card application data according to an exemplary embodiment. As shown in FIG. 6, the device includes a receiving module 61, an acquiring module 62, an extracting module 63, an entering module 64 and a submitting module 65.

The receiving module 61 is configured to receive a card application request. The acquiring module 62 is configured to acquire, in response to the card application request received by the receiving module 61, historical communication data including user information of a user required for card application. The extracting module 63 is configuregwd to extract the user information from the historical communication data acquired by the acquiring module 62. The entering module 64 is configured to enter the user information extracted by the extracting module 63 into a card application page. The submitting module 65 is configured to receive a submission request, and submit, according to the submission request, the card application page into which the entering module 64 writes the user information.

In one embodiment, the entering module 64 may be configured to match the user information to an entry to be filled in on the card application page, and enter, according to a matching result, the user information into an entry to be filled in corresponding to the user information. The device shown in FIG. 6 is configured to implement the method shown in FIG. 1, content description involved thereof is the same and will not be repeated here.

With the device for processing card application data according to the embodiment, the acquiring module acquires the historical communication data including the user information of a user required for card application according to the received card application request, the extracting module extracts the user information from the historical communication data, and the entering module correspondingly writes the extracted user information into the card application page, such that the user is not required to manually fill in the user information, saving time and trouble, reducing a probability of error, facilitating online card application by the user.

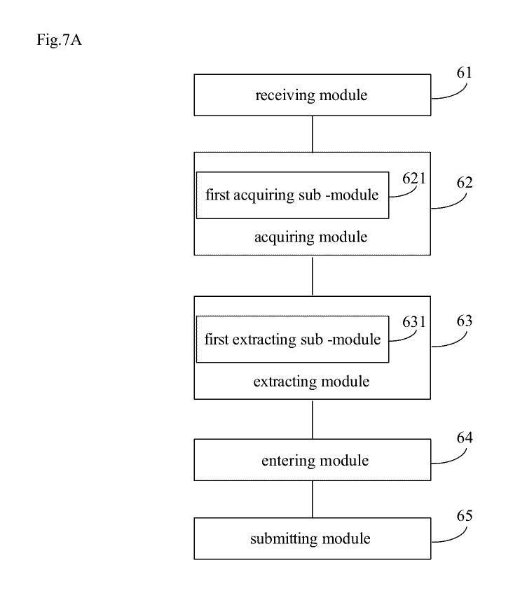

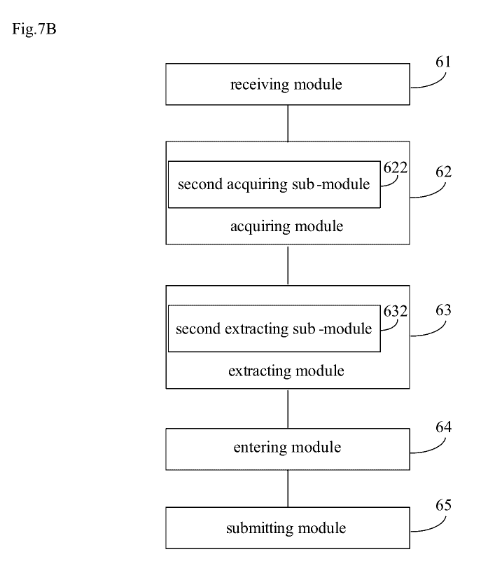

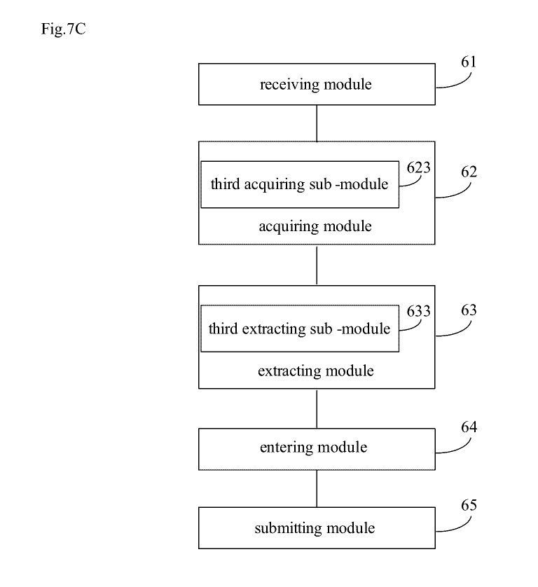

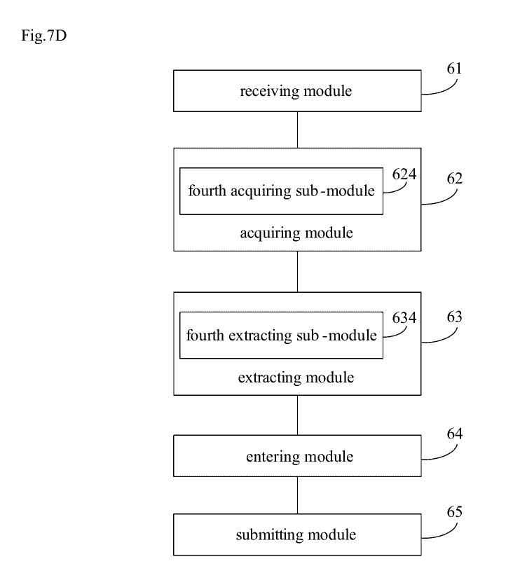

FIG. 7A is a block diagram of another device for processing card application data according to an exemplary embodiment. As shown in FIG. 7A, based on the embodiment shown in FIG. 6, the acquiring module 62 may include a first acquiring sub-module 621.

The first acquiring sub-module 621 may be configured to acquire, according to the card application request, a short message including financial information. The extracting module 63 may include a first extracting sub-module 631. The first extracting sub-module 631 may be configured to analyze the short message acquired by the first acquiring sub-module 621, and extract income information of the user according to a result of the analysis.

The device shown in FIG. 7A may be configured for implementing the method shown in FIG. 2, and content description involved thereof is the same and will not be repeated here. In the abovementioned embodiment, the acquired short message including the financial information is unlikely to be faked, so that the user information extracted from the historical communication data are more objective and accurate, increasing data authenticity, reducing a deviation due to manually filling in information by the user, reducing a risk of the card issuing agency. In addition, user information may be extracted in multiple modes that are easy to implement.

FIG. 7B is a block diagram of another device for processing card application data according to an exemplary embodiment. As shown in FIG. 7B, based on the embodiment shown in FIG. 6, the acquiring module 62 may include a second acquiring sub-module 622.

The second acquiring sub-module 622 may be configured to acquire, according to the card application request, payment account registration information.

The extracting module 63 may include a second extracting sub-module 632. The second extracting sub-module 632 may be configured to extract identity information of the user from the payment account registration information acquired by the second acquiring sub-module 622.

The device shown in FIG. 7B may be configured to implement the method shown in FIG. 2, and content description involved thereof is the same and will not be repeated here. In the abovementioned embodiment, the acquired payment account registration information is checked to be objective, authentic and unlikely to be faked, so that the user information extracted from the historical communication data are more objective and accurate, increasing data authenticity, reducing a deviation due to manually filling in information by the user, reducing a risk of the card issuing agency. In addition, user information may be extracted flexibly in multiple modes that are easy to implement.

FIG. 7C is a block diagram of another device for processing card application data according to an exemplary embodiment. As shown in FIG. 7C, based on the embodiment shown in FIG. 6, the acquiring module 62 may include a third acquiring sub-module 623. The third acquiring sub-module 623 may be configured for: acquiring a historical payment record according to the card application request.

The extracting module 63 may include a third extracting sub-module 633. The third extracting sub-module 633 may be configured for: extracting a mailing address of the user from the historical payment record acquired by the third acquiring sub-module 623.

The device shown in FIG. 7C may be configured for implementing the method shown in FIG. 2, and content description involved thereof is the same and will not be repeated here. In the abovementioned embodiment, the acquired historical payment record is unlikely to be faked, so that the user information extracted from the historical communication data are more objective and accurate, increasing data authenticity, reducing a deviation due to manually filling in information by the user, reducing a risk of the card issuing agency. In addition, information may be extracted flexibly in multiple modes that are easy to implement.

FIG. 7D is a block diagram of another device for processing card application data according to an exemplary embodiment. As shown in FIG. 7D, based on the embodiment shown in FIG. 6, the acquiring module 62 may include a fourth acquiring sub-module 624. The fourth acquiring sub-module 624 may be configured to acquire email client data according to the card application request.

The extracting module 63 may include a fourth extracting sub-module 634. The fourth extracting sub-module 634 may be configured to extract email information of the user from the email client data acquired by the fourth acquiring sub-module 624.

The device shown in FIG. 7D may be configured for implementing the method shown in FIG. 2, and content description involved thereof is the same and will not be repeated here.

In the abovementioned embodiment, the acquired email client data are unlikely to be faked, so that the user information extracted from the historical communication data are more objective and accurate, increasing data authenticity, reducing a deviation due to manually filling in information by the user, reducing a risk of the card issuing agency. User information may be extracted flexibly in multiple modes that are easy to implement.

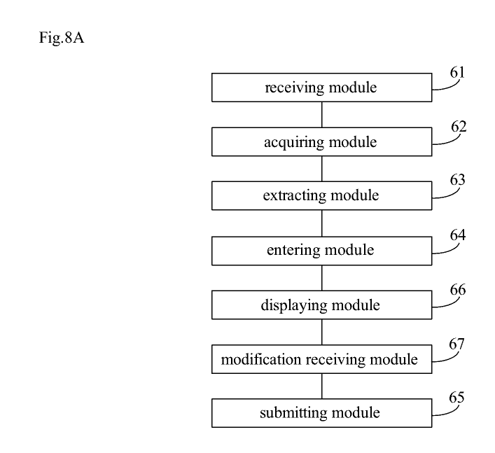

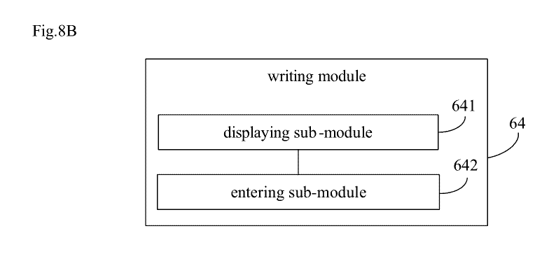

FIG. 8A is a block diagram of another device for processing card application data according to an exemplary embodiment. As shown in FIG. 8A, based on the embodiment shown in FIG. 6, the device may further include a displaying module 66 and a modification receiving module 67.

The displaying module 66 may be configured to before the submitting module 65 receives the submission request, display prompting information for prompting the user to check the user information.

The modification receiving module 67 may be configured to receive information on user modification to the card application page.

The device shown in FIG. 8A may be configured for implementing the method shown in FIG. 5, and content description involved thereof is the same and will not be repeated here.

In the abovementioned embodiment, the prompting information may be displayed to prompt the user to check the information, and the information on user modification to the card application page may be received, increasing accuracy of the user information.

FIG. 8B is a block diagram of another device for processing card application data according to an exemplary embodiment. As shown in FIG. 8B, based on the embodiment shown in FIG. 6, the entering module 64 may include a displaying sub-module 641 and an entering sub-module 642.

The displaying sub-module 641 may be configured to receive a trigger instruction for triggering an entry to be filled in on the card application page, and display, according to the trigger instruction, the user information corresponding to the triggered entry to be filled in.

The entering sub-module 642 may be configured to receive an entering instruction for entering the user information displayed by the displaying sub-module 641, and entering, according to the writing instruction, the displayed user information into the triggered entry to be filled in.

The device shown in FIG. 8B may be configured for implementing the method shown in FIG. 1, and content description involved thereof is the same and will not be repeated here.

In the abovementioned embodiment, extracted information may be written into the card application page based on an operation of the user, such that a workload for manually inputting information by the user may be effectively reduced.

A specific mode in which a module or a sub-module of the device in an aforementioned embodiment executes an operation has been elaborated in a corresponding method embodiment and will not be repeated here.

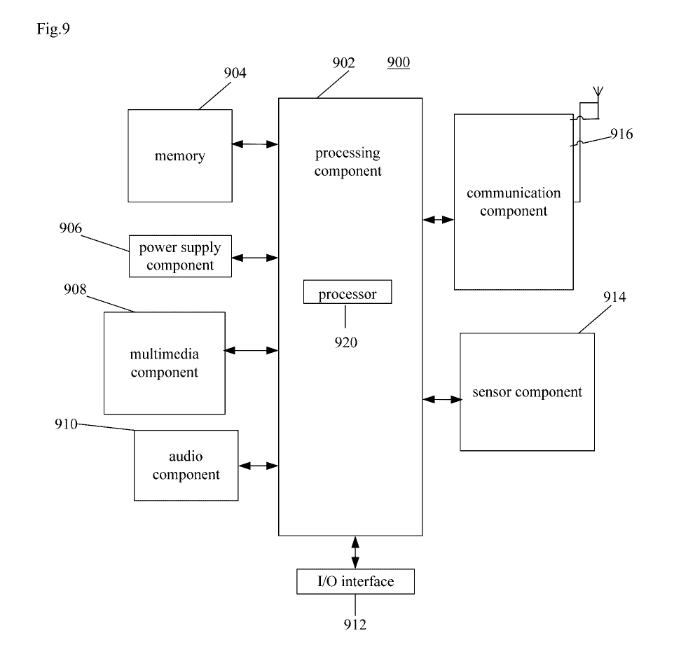

FIG. 9 is a block diagram of a device for processing card application data, according to an exemplary embodiment. For example, the device 900 may be a mobile phone, a computer, a digital broadcast terminal, a message transceiver, a gaming console, a tablet equipment, medical equipment, fitness equipment, a Personal Digital Assistant, an aircraft, and/or the like.

Referring to FIG. 9, the device 900 may include one or more components as follows: a processing component 902, a memory 904, a power supply component 906, a multimedia component 908, an audio component 910, an Input/Output (I/O) interface 912, a sensor component 914, and a communication component 916.

The processing component 902 generally controls an overall operation of the device 900, such as operations associated with display, a telephone call, data communication, a camera operation, and a recording operation. The processing component 902 may include one or more processors 920 to execute instructions so as to complete all or some steps of the method. In addition, the processing component 902 may include one or more modules to facilitate interaction between the processing component 902 and other components. For example, the processing component 902 may include a multimedia module to facilitate interaction between the multimedia component 908 and the processing component 902.

The memory 904 may be configured for storing various types of data to support the operation on the device 900. Example of such data may include instructions of any application or method configured for operating on the device 900, contact data, phonebook data, messages, pictures, videos, and/or the like. The memory 904 may be realized by any type of volatile or non-transitory storage equipment or combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or compact disk.

The power supply component 906 may supply electric power to various components of the device 900. The power supply component 906 may include a power management system, one or more power sources, and other components related to generating, managing and distributing electricity for the device 900.

The multimedia component 908 may include a screen providing an output interface between the device 900 and a user. In some embodiments, the screen may include a Liquid Crystal Display (LCD) and a Touch Panel (TP). If the screen includes a TP, the screen may be realized as a touch screen to receive an input signal from a user. The TP may include one or more touch sensors for sensing touch, slide and gestures on the TP. The touch sensors not only may sense the boundary of a touch or slide move, but also detect the duration and pressure related to the touch or slide move. In some embodiments, the multimedia component 908 may include a front camera and/or a rear camera. When the device 900 is in an operation mode such as a shooting mode or a video mode, the front camera and/or the rear camera may receive external multimedia data. Each of the front camera and the rear camera may be a fixed optical lens system or may have a focal length and be capable of optical zooming

The audio component 910 may be configured for outputting and/or inputting an audio signal. For example, the audio component 910 may include a microphone (MIC). When the device 900 is in an operation mode such as a call mode, a recording mode, and a voice recognition mode, the MIC may be configured for receiving an external audio signal. The received audio signal may be further stored in the memory 904 or may be sent via the communication component 916. In some embodiments, the audio component 910 may further include a loudspeaker configured for outputting the audio signal.

The I/O interface 912 may provide an interface between the processing component 902 and a peripheral interface module. Such a peripheral interface module may be a keypad, a click wheel, a button or the like. Such a button may include but is not limited to: a homepage button, a volume button, a start button, and a lock button.

The sensor component 914 may include one or more sensors for assessing various states of the device 900. For example, the sensor component 914 may detect an on/off state of the device 900 and relative positioning of components such as the display and the keypad of the device 900. The sensor component 914 may further detect a change in the position of the device 900 or of a component of the device 900, whether there is contact between the device 900 and a user, the orientation or acceleration/deceleration of the device 900, and a change in the temperature of the device 900. The sensor component 914 may include a proximity sensor configured for detecting existence of a nearby object without physical contact. The sensor component 914 may further include an optical sensor such as a Complementary Metal-Oxide-Semiconductor (CMOS) or Charge-Coupled-Device (CCD) image sensor used in an imaging application. In some embodiments, the sensor component 914 may further include an acceleration sensor, a gyroscope sensor, a magnetic sensor, a pressure sensor, or a temperature sensor.

The communication component 916 may be configured for facilitating wired or wireless communication between the device 900 and other equipment. The device 900 may access a wireless network based on a communication standard such as WiFi, 2G or 3G, or combination thereof. In an exemplary embodiment, the communication component 1116 may receive a broadcast signal or broadcast related information from an external broadcast management system via a broadcast channel. In an exemplary embodiment, the communication component 916 may further include a Near Field Communication (NFC) module for short-range communication. For example, the NFC module may be based on Radio Frequency Identification (RFID), Infrared Data Association (IrDA), Ultra-Wideband (UWB) technology, Bluetooth (BT), and other technologies.

In an exemplary embodiment, the device 900 may be realized by one or more of Application Specific Integrated Circuits (ASIC), Digital Signal Processors (DSP), Digital Signal Processing Device (DSPD), Programmable Logic Devices (PLD), Field Programmable Gate Arrays (FPGA), controllers, microcontrollers, microprocessors or other electronic components to implement the method.

In an exemplary embodiment, a non-transitory computer-readable storage medium including instructions, such as a memory 904 including instructions, may be provided. The instructions may be executed by the processor 920 of the device 900 to implement the method. For example, the non-transitory computer-readable storage medium may be a Read-Only Memory (ROM), a Compact Disc Read-Only Memory (CD-ROM), a magnetic tape, a floppy disk, optical data storage equipment, etc.

Each module discussed above, such as the receiving module 61, the acquiring module 62, the extracting module 63, the entering module 64, and the submitting module 65, may take the form of a packaged functional hardware unit designed for use with other components, a portion of a program code (e.g., software or firmware) executable by the processor 920 or the processing circuitry that usually performs a particular function of related functions, or a self-contained hardware or software component that interfaces with a larger system, for example.

Other embodiments herein will be apparent to those skilled in the art from consideration of the specification and practice of the invention disclosed here. This application is intended to cover any variations, uses, or adaptations of the disclosure following the general principles thereof and including such departures from the present disclosure as come within known or customary practice in the art. The specification and the embodiments are intended to be exemplary only, with a true scope and spirit of the disclosure being indicated by the appended claims.

Note that the present disclosure is not limited to the exact construction that has been described above and illustrated in the accompanying drawings, and that various modifications and changes can be made without departing from the scope thereof. It is intended that the scope of the present disclosure be limited only by the appended claims.

With a technical solution according to an embodiment herein, historical communication data including user information of a user required for card application may be acquired according to a received card application request. The user information may be extracted from the historical communication data. The extracted user information may be correspondingly written into a card application page, such that the user is not required to manually fill in the user information, saving time and trouble, reducing a probability of error, facilitating online card application by the user.

The acquired short message including the financial information is unlikely to be faked, so that the user information extracted from the historical communication data are more objective and accurate, increasing data authenticity, reducing a deviation due to manually filling in information by the user, reducing a risk of the card issuing agency. User information may be extracted flexibly in multiple modes that are easy to implement.

The acquired payment account registration information is checked to be objective, authentic and unlikely to be faked, so that the user information extracted from the historical communication data are more objective and accurate, increasing data authenticity, reducing a deviation due to manually filling in information by the user, reducing a risk of the card issuing agency. User information may be extracted flexibly in multiple modes that are easy to implement.

The acquired historical payment record is unlikely to be faked, so that the user information extracted from the historical communication data are more objective and accurate, increasing data authenticity, reducing a deviation due to manually filling in information by the user, reducing a risk of the card issuing agency. User information may be extracted flexibly in multiple modes that are easy to implement.

The acquired email client data are unlikely to be faked, so that the user information extracted from the historical communication data are more objective and accurate, increasing data authenticity, reducing a deviation due to manually filling in information by the user, reducing a risk of the card issuing agency. User information may be extracted flexibly in multiple modes that are easy to implement.

The extracted information may be automatically written into the card application page. With such a simple information writing process, a page turning operation due to a small screen of a mobile terminal such as a mobile phone may be avoided.

Extracted information may be written into the card application page based on an operation of the user, such that a workload for manually inputting information by the user may be effectively reduced.

By displaying prompting information, the user may be prompted to check the information. The information on user modification to the card application page may be received, improving accuracy of the user information.

What is claimed is:

1. A method for processing an online application form, comprising:
receiving, by a receiving module of a smart device, an online application request associated with a user;
acquiring, by an acquiring module of the smart device, historical communication data related to the user in response to the online application request;
extracting, by an extracting module of the smart device, user information from the historical communication data;
displaying, by a displaying module of the smart device, the online application form on a screen of the smart device; and
entering, by an entering module of the smart device, the user information into the online application form.

2. The method according to claim 1, wherein the historical communication data comprises a short message communicated by the user.

3. The method according to claim 1, wherein the historical communication data comprises payment method information, and the user information comprises identity information of the user.

4. The method according to claim 1, wherein the historical communication data comprises a payment history record related to the user, and the user information comprises a mailing address of the user.

5. The method according to claim 1, wherein the historical communication data comprises email client data, and the user information comprises email information of the user.

6. The method according to claim 1, wherein entering the user information into the online application form comprises:
tagging the user information with a predetermined category; and
matching the user information to an entry of the online application form based on the predetermined type.

7. The method according to claim 6, wherein the predetermined category is selected from a group consisting of an identification, an email address, an income, and a mailing address.

8. The method according to claim 2, wherein the short message comprises a direct deposit message for the user.

9. The method according to claim 2, wherein the short message comprises income information of the user.

10. A device for processing card application data, comprising:
a processor; and
a memory configured for storing an instruction executable by the processor,
wherein the processor is configured for:
receiving an online card application request from a user;
acquiring, according to the online card application request, historical communication data related to the user in response to the card application request;
extracting user information from the historical communication data;
displaying an online card application form on a screen of the device; and
entering the user information into the online card application form.

11. The device according to claim 10, wherein the historical communication data comprises a short message communicated by the user, and the user information comprises income information of the user.

12. The device according to claim 10, wherein the historical communication data comprises payment method information, and the user information comprises identity information of the user.

13. The device according to claim 10, wherein the historical communication data comprises payment history related to the user, and the user information comprises a mailing address of the user.

14. The device according to claim 10, wherein the historical communication data comprises email client data, and the user information comprises email information of the user.

15. The device according to claim 10, wherein the entering the user information into an online card application form comprises:
tagging the user information with a predetermined category; and
matching the user information to an entry of the online card application form based on the predetermined category.

16. The device according to claim 15, wherein the predetermined category is selected from a group consisting of an identification, an email address, an income, and a mailing address.

17. A non-transitory computer-readable storage medium having stored therein instructions that, when executed by a processor, cause the processor to perform a method for processing card application data, the method comprising:
receiving a card application request from a user;
acquiring historical communication data related to user in response to the card application request;
extracting user information from the historical communication data;
displaying an online card application form on a display; and
entering the user information into the online card application form.

18. The storage medium according to claim 17, wherein the historical communication data comprises a short message communicated by the user, and the user information comprises income information of the user.

19. The storage medium according to claim 17, wherein the historical communication data comprises payment method information, and the user information comprises identity information of the user.

20. The storage medium according to claim 17, wherein the historical communication data comprises payment history related to the user, and the user information comprises a mailing address of the user.
